(19) United States
(12) Patent Application Publication
(10) Pub. No.: US 2026/0100492 A1
(43) Pub. Date: Apr. 9, 2026

(54) SECONDARY BATTERY ZIG DEVICE AND OPERATING METHOD FOR THE SAME

(71) Applicant: SAMSUNG SDI CO., LTD., Yongin-si (KR)

(72) Inventor: Euidu JIN, Yongin-si (KR)

(21) Appl. No.: 19/242,002

(22) Filed: Jun. 18, 2025

(30) Foreign Application Priority Data
Oct. 4, 2024 (KR) 10-2024-0134897

(51) Int. Cl. H01M 50/595

(52) U.S. Cl. CPC H01M 50/595

(57) ABSTRACT

A zig device for a secondary battery, the zig device including a first plate supporting a first surface of an electrode assembly, a second plate supporting a second surface of the electrode assembly, the second plate facing the first plate while being spaced apart therefrom, and a supporting zig coupled with the second plate, the supporting zig supporting a sub-plate coupled to a side surface of the electrode assembly, the electrode assembly being between the first plate and the second plate.

### CROSS-REFERENCE TO RELATED APPLICATION

The present application claims priority to and the benefit of Korean Application No. 10-2024-0134897, filed on October 4, 2024, in the Korean Intellectual Property Office, the entire disclosure of which is incorporated by reference herein.

### BACKGROUND

### 1. Field

The present disclosure relates to a zig device for a secondary battery and a method of operating the same.

### 2. Description Of The Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

When two materials with different electrodes in a secondary battery come into electrical contact with each other and an internal short occurs, the temperature of the secondary battery may rise rapidly, which may even lead to a fire. To prevent two materials with different electrodes from coming into electrical contact with each other inside a secondary battery, an insulating component may be arranged inside the secondary battery.

Secondary batteries are classified into coin-shaped batteries, cylindrical batteries, square batteries, and pouch-shaped batteries according to the shape of the battery cases. An electrode assembly mounted inside a case of a secondary battery is a rechargeable device for power generation in a structure in which a positive electrode, a separator, and a negative electrode are stacked. Electrode assemblies can be largely classified into jellyroll-type electrode assemblies wound with a separator interposed between sheet-shaped positive and negative electrodes coated with active materials, stacked electrode assemblies where multiple positive and negative electrodes are sequentially stacked with separators interposed therebetween, and stacked or folded electrode assemblies where stacked unit cells are wound with a long separation film.

The above information disclosed in this Background section is for enhancement of understanding of the background of the present disclosure, and therefore, it may contain information that does not constitute related (or prior) art.

### SUMMARY

Embodiments include a zig device for a secondary battery, the zig device including a first plate supporting a first surface of an electrode assembly, a second plate supporting a second surface of the electrode assembly, the second plate facing the first plate while being spaced apart therefrom, and a supporting zig coupled with the second plate, the supporting zig supporting a sub-plate coupled to a side surface of the electrode assembly, the electrode assembly being between the first plate and the second plate.

The supporting zig may include a base portion coupled to an edge portion of the second plate, an extension portion extending from the base portion and protruding outward from the second plate, and a support portion extending vertically from the extension portion, the support portion being between the electrode assembly and the sub-plate.

A length by which the extension portion protrudes outward may be equal to or greater than a length by which the electrode assembly protrudes from the second plate.

The support portion may include a magnet having a magnetic force.

The support portion may include a protrusion on an outside thereof.

The sub-plate may include a connecting portion and wing portions extending from each side of the connecting portion, the connecting portion including a boss portion protruding from the connecting portion.

The connecting portion may be coupled with the wing portion, and the support portion may be in a space created by the step.

The sub-plate may include a plurality of sub-plates coupled to the side surface of the electrode assembly, wherein the support zig may include a plurality of supporting zigs to support the plurality of sub-plates.

A distance between the plurality of supporting zigs may correspond to a distance between the plurality of sub-plates.

The zig device may further include a clamp for clamping the first plate and the second plate.

The zig device may further include a position correction zig coupled with the boss portion and the protrusion, the correction zig correcting a position of the sub-plate.

The position correction zig may include a plurality of fastening portions coupled to the boss portion and the protrusion, and a bridge portion connecting the plurality of fastening portions.

A length of the bridge portion may correspond to a distance between adjacent sub-plates of the plurality of sub-plates.

The fastening portion may be coupled with the protrusion and the boss portion, wherein the fastening portion has a first hole and a second hole.

Embodiments include a method of operating a zig device for a secondary battery, the method including supporting a first surface of an electrode assembly with a first plate, inserting a supporting zig coupled with a second plate into a space between the electrode assembly and a sub-plate, the sub-plate being coupled to a side surface of the electrode assembly, the electrode assembly being interposed between the first plate and the second plate, and supporting a second surface of the electrode assembly with the second plate, the second plate facing the first plate and being spaced apart therefrom.

Inserting the supporting zig may include inserting a support portion of the supporting zig into a space between the electrode assembly and the sub-plate.

The sub-plate may include a connecting portion and wing portions extending from each side of the connecting portion, the connecting portion may form a step with the wing portion, and the connecting portion may include a boss portion protruding from the connecting portion.

Inserting the support portion of the supporting zig may include inserting the support portion into a space formed by the step.

The method may further include coupling a position correction zig with the boss portion and a protrusion of the support portion.

The method may further include attaching an insulating tape to the electrode assembly and the sub-plate.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 is a perspective view of a zig device for a secondary battery according to an embodiment of the present disclosure;

FIG. 2 is a perspective view of an electrode assembly coupled with a sub-plate, which is inserted into the zig device according to an embodiment of the present disclosure;

FIG. 3 is a cross-sectional view of the electrode assembly coupled with the sub-plate and inserted into the zig device according to an embodiment of the present disclosure;

FIG. 4 is a cross-sectional view of a supporting zig according to an embodiment of the present disclosure;

FIG. 5 is a perspective view of the sub-plate according to an embodiment of the present disclosure;

FIG. 6 is a cross-sectional view of a position correction zig according to an embodiment of the present disclosure;

FIG. 7 is a cross-sectional view of the zig device coupled with a clamp according to an embodiment of the present disclosure;

FIG. 8 is a flowchart for illustrating a method of operating the zig device for a secondary battery according to an embodiment of the present disclosure; and

FIGS. 9A to 9E show each process of the method of operating the zig device for a secondary battery according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

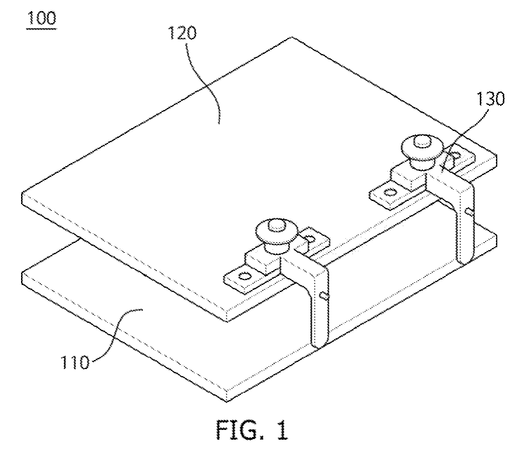

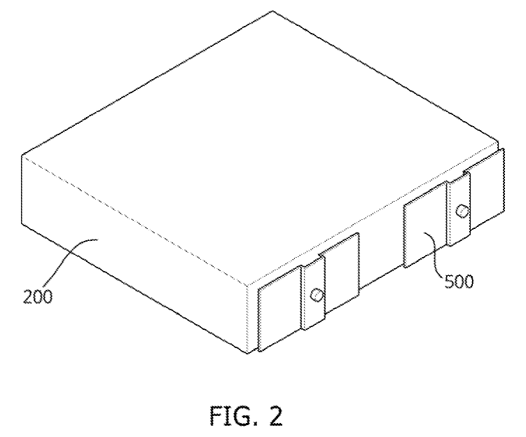

FIG. 1 is a perspective view of a zig device for a secondary battery according to an embodiment of the present disclosure, and FIG. 2 is a perspective view of an electrode assembly coupled with a sub-plate, which is inserted into the zig device according to an embodiment of the present disclosure.

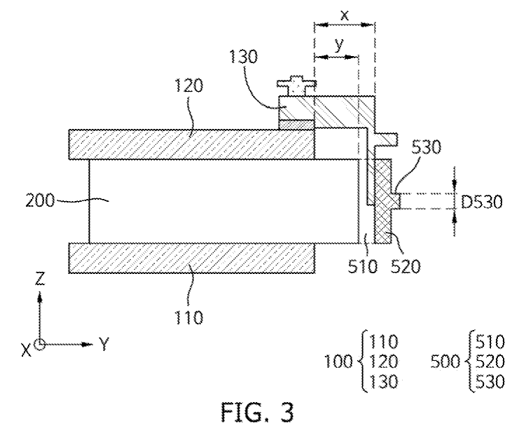

Referring to FIG. 1, a zig device 100 for a secondary battery according to an embodiment of the present disclosure may include a first plate 110, a second plate 120, and a supporting zig 130. The first plate 110 and the second plate 120 may face each other and may be spaced apart from each other. The area of the first plate 110 may correspond to (e.g., be the same as) the area of the second plate 120. The supporting zig 130 may be coupled with the edge portion of the second plate 120. The edge portion of the second plate 120 may correspond to an edge portion adjacent to a sub-plate 500 of an electrode assembly 200, the electrode assembly 200 interposed between the two plates. The zig device will be described in more detail with reference to FIG. 3 and the following drawings.

Referring to FIG. 2, the sub-plate 500 may be coupled to a side surface of the electrode assembly 200. For example, the sub-plate 500 and the electrode assembly 200 may be welded together. A plurality of sub-plates 500 may be coupled to the side surface of the electrode assembly 200.

The electrode assembly 200 may be formed by alternately stacking a plurality of first electrodes, a plurality of separators, and a plurality of second electrodes, which are formed in the shape of a thin plate or film. The electrode assembly 200 may be a stacked electrode assembly. For another example, the electrode assembly 200 may be a Z-stack electrode assembly in which a first electrode and a second electrode are inserted into each side of a separator folded into a Z-stack. The first electrode of the electrode assembly 200 may serve as an anode, and the second electrode may serve as a cathode. In other embodiments, the opposite is also true.

The first electrode may be formed by applying a first electrode active material such as a transition metal oxide onto a first electrode substrate formed of a metal foil such as aluminum or an aluminum alloy, and may include a first electrode tab or first uncoated portion, which is the region where the first electrode active material is not applied. The first electrode tab may serve as a passage through which current flows between the first electrode and a first collector plate.

The second electrode may be formed by applying a second electrode active material such as graphite or carbon onto a second electrode substrate formed of a metal foil such as copper, a copper alloy, nickel, or a nickel alloy, and may include a second electrode tab or second uncoated portion, which is the region where the second electrode active material is not applied. The second electrode tab may serve as a passage through which current flows between the second electrode and a second collector plate.

The separator may prevent short circuiting between the first electrode and the second electrode while allowing the movement of lithium ions. For example, the separator may be formed of a polyethylene film, a polypropylene film, a polyethylene-polypropylene film, etc., but the separator material(s) may vary.

The electrode assembly 200 coupled with the sub-plate 500 may be interposed between the first plate 110 and the second plate 120. The first plate 110 may support one surface (e.g., the bottom surface in the orientation shown) of the electrode assembly 200, and the second plate 120 may support the other surface (e.g., the top surface in the orientation shown) of the electrode assembly 200.

One surface or the other surface of the electrode assembly 200 may be formed by the first electrode, the second electrode, or the separator. For example, one surface or the other surface of the electrode assembly 200 may be formed by the separator. One surface or the other surface of the electrode assembly 200 may correspond to a surface perpendicular to the direction in which the first electrode, the second electrode, and the separator are stacked. A side surface of the electrode assembly 200 may correspond to a surface parallel to the direction in which the first electrode, the second electrode, and the separator are stacked. An electrode tab may be positioned on the side surface of the electrode assembly 200. The sub-plate 500 coupled to the side surface of the electrode assembly 200 may be electrically connected to the electrode tab.

In some embodiments, a plurality of supporting zigs 130 may be provided to support each of the plurality of sub-plates 500 coupled to the side surface of the electrode assembly 200. The number of the supporting zigs 130 may correspond to (e.g., may match) the number of the sub-plates 500 coupled to the side surface of the electrode assembly 200. The position of the supporting zig 130 may correspond to the position of the sub-plate 500 coupled to the side surface of the electrode assembly 200. The distance between the plurality of supporting zigs 130 may correspond to the distance between the plurality of sub-plates 500.

According to the present disclosure, all the electrodes may be formed on one side surface of the electrode assembly 200, but each electrode may be formed on each of the opposing side surfaces of the electrode assembly 200. In this case, the supporting zig 130 may be coupled to the second plate 120 at a plurality of edge portions of the second plate 120. The edge portion of the second plate 120 may correspond to the edge portion adjacent to the sub-plate 500.

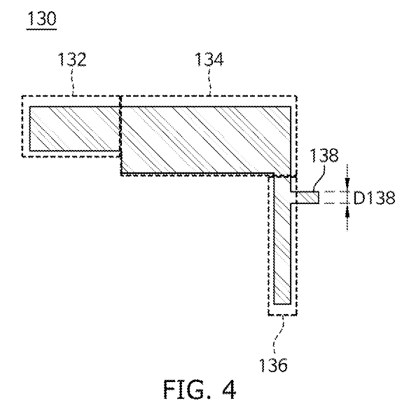

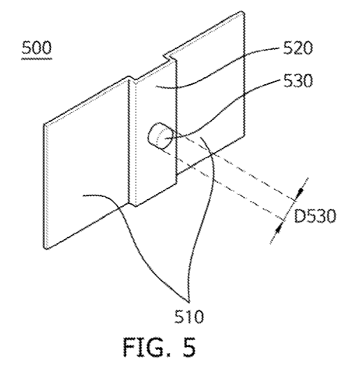

FIG. 3 is a cross-sectional view of the electrode assembly coupled with the sub-plate and inserted into the zig device according to an embodiment of the present disclosure, and FIG. 4 is a cross-sectional view of the supporting zig according to an embodiment of the present disclosure. FIG. 5 is a perspective view of the sub-plate according to an embodiment of the present disclosure.

Referring to FIGS. 3 and 4, the supporting zig 130 may include a base portion 132, an extension portion 134, and a support portion 136.

A first direction X may mean the X-axis direction illustrated in FIG. 3. A second direction Y may be orthogonal to the first direction X. The second direction Y may mean the Y-axis direction. A third direction Z may be orthogonal to each of the first direction X and the second direction Y. The third direction Z may mean the Z-axis direction. The first direction and the second direction may be perpendicular to the stacking direction of the electrode assembly 200, and the third direction may be parallel to the stacking direction of the electrode assembly 200.

The base portion 132 may be coupled to the edge portion of the second plate 120. For example, the base portion 132 may be coupled to the edge portion of the second plate 120 by a bolt. The edge portion may include the upper surface of the second plate 120 and may correspond to the edge closest to the electrode assembly 200 coupled with the sub-plate 500. Here, the upper surface is referred to as an upper surface for convenience of description based on the zig device 100 in FIG. 3 (in the orientation shown), and the upper surface of the second plate 120 may correspond to a surface that is perpendicular to the third direction and exposed to the outside. The lower surface of the second plate 120 may be a surface facing the upper surface and may correspond to a surface in contact with the electrode assembly 200. The positions of the upper and lower surfaces may change when the zig device 100 rotates left and right or up and down.

The extension portion 134 may extend from the base portion 132 and protrude outward from the second plate 120. For example, the extension portion may extend from the base portion 132 in the second direction, i.e., the Y-axis direction. A length x (see FIG. 3) by which the extension portion 134 protrudes from the second plate 120 may be equal to or greater than a length y by which the electrode assembly 200 protrudes from the second plate 120. For example, the length x by which the extension portion 134 protrudes from the second plate 120 may be equal to or greater than the length y by which the electrode assembly 200 protrudes from the second plate 120 plus the length of the thickness of the support portion 136.

The support portion 136 may extend vertically from the extension portion 134 and may be inserted into the space between the electrode assembly 200 and the sub-plate 500. The support portion 136 may include a magnet that provides a magnetic force. The support portion 136 may include a protrusion 138. The protrusion 138 may be formed on the outside of the support portion 136. For example, the protrusion 138 may protrude from the support portion 136 in the second direction Y. The protrusion 138 may have a diameter D138.

Referring to FIGS. 3 and 5, the sub-plate 500 may be coupled to the side surface of the electrode assembly 200 and may be electrically connected to an electrode tab, such as a positive electrode tab, of the electrode assembly 200.

The sub-plate 500 may include a connecting portion 520 and wing portions 510 extending from each side of the connecting portion 520. The connecting portion 520 and the wing portions 510 may be connected to each other with a step. The support portion 136 of the supporting zig 130 may be inserted into a space formed by the step. The thickness of the step may be thicker than the thickness of the support portion 136. A portion of the support portion 136 may be in contact with the connecting portion 520.

The sub-plate 500 may be coupled to the electrode tab of the electrode assembly 200. For example, the wing portions 510 of the sub-plate 500 may be coupled to the electrode tab by welding. The wing portions 510 of the sub-plate 500 may be connected to the electrode tab and electrically connected to the electrode.

The connecting portion 520 of the sub-plate 500 may include a boss portion 530 protruding from the connecting portion 520. The boss portion 530 may have a diameter D530. According to an embodiment, the boss portion 530 may be formed on a separate current collector, and the current collector may be coupled with the connecting portion 520. In this case, the sub-plate 500 may include the current collector having the boss portion 530 formed thereon. The current collector may include a flat portion coupled with the connecting portion 520 of the sub-plate and the boss portion 530 that protrudes on the flat portion. The boss portion 530 may protrude in the second direction Y opposite to a direction in which it faces the electrode assembly 200.

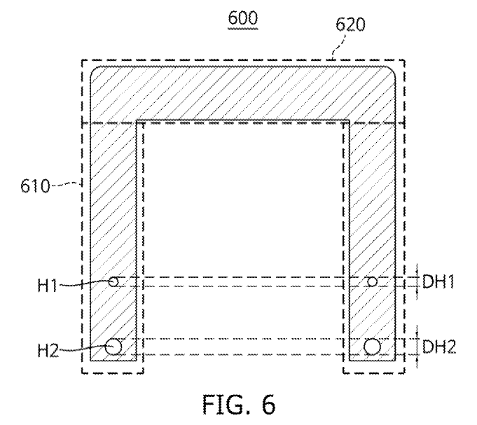

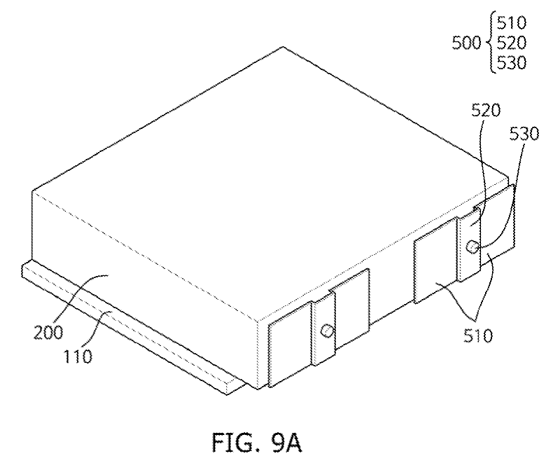

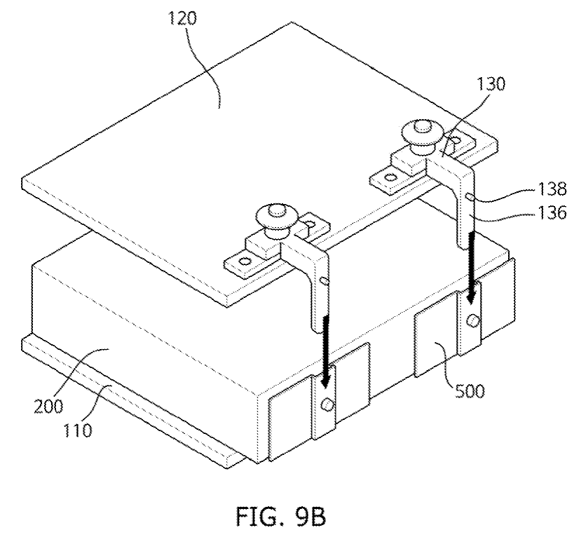

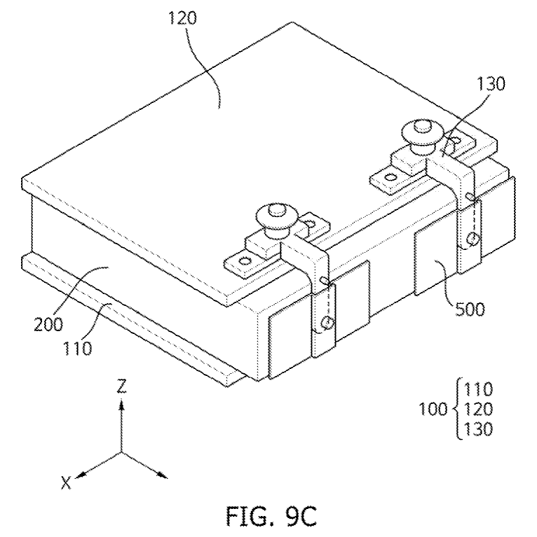

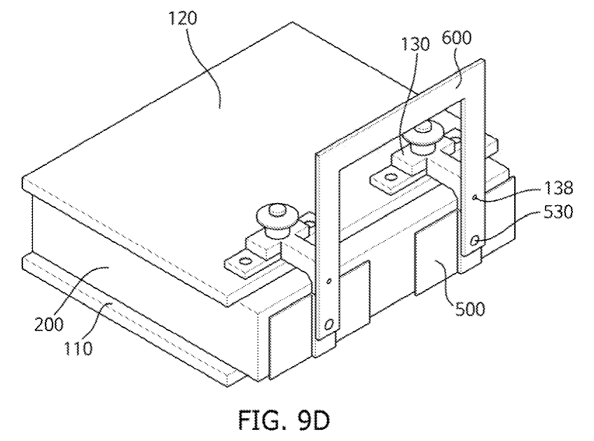

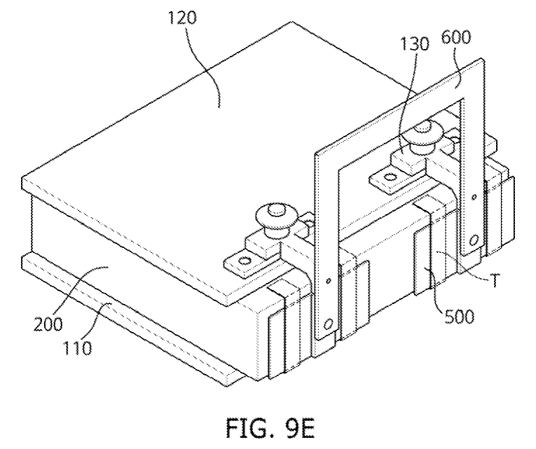

FIG. 6 is a cross-sectional view of a position correction zig according to an embodiment of the present disclosure. A position correction zig 600 may be coupled with the boss portion 530 of the sub-plate 500 and the protrusion 138 of the supporting zig 130. The structure in which they are coupled to each other is illustrated in FIG. 9.

Referring to FIG. 6, the position correction zig 600 may include a plurality of fastening portions 610 and a bridge portion 620 connecting the plurality of fastening portions 610. The length of the bridge portion 620 may correspond to the distance between the fastening portions 610 or the distance between the sub-plates 500. For example, the length of the bridge portion 620 may correspond to the distance between the boss portions 530 of the sub-plates 500 or the distance between the protrusions 138 of the supporting zigs 130.

The fastening portions 610 may include a first hole H1 and a second hole H2. The first hole H1 may be located above the second hole H2. The diameter DH1 of the first hole may be smaller than the diameter DH2 of the second hole.

The position correction zig 600 may be coupled with the protrusion 138 and the boss portion 530. Specifically, the protrusion 138 may penetrate the first hole H1, and the boss portion 530 may penetrate the second hole H2. In other embodiments, the protrusion 138 may be inserted into the first hole H1, and the boss portion 530 may be inserted into the second hole H2. The diameter D138 of the protrusion may be smaller than the diameter DH1 of the first hole, and the diameter D530 of the boss portion may be smaller than the diameter DH2 of the second hole.

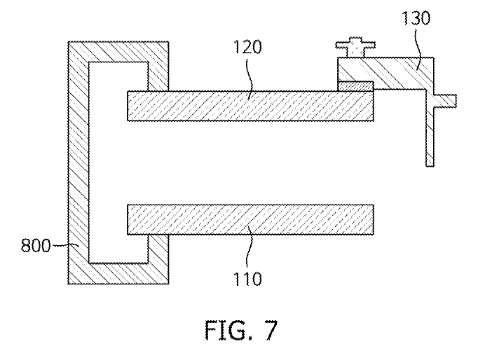

FIG. 7 is a cross-sectional view of the zig device coupled with a clamp according to an embodiment of the present disclosure.

The zig device 100 for a secondary battery may include a clamp 800 that clamps the first plate 110 and the second plate 120. The clamp may be in contact with the lower surface of the first plate 110 and the upper surface of the second plate 120. The clamp 800 may apply upward pressure to the lower surface of the first plate 110 and downward pressure to the upper surface of the second plate 120. The plates may be moved by the pressure applied by the clamp 800 to the first plate 110 and the second plate 120. With the pressure applied by the clamp 800, the first plate 110 and the second plate 120 may support the electrode assembly 200 interposed between the plates. The upper surface of the first plate 110 and the lower surface of the second plate 120 may each support the electrode assembly 200. For example, in the process of attaching an insulating tape to the electrode assembly and the sub-plate, the clamp may support or fix the electrode assembly 200.

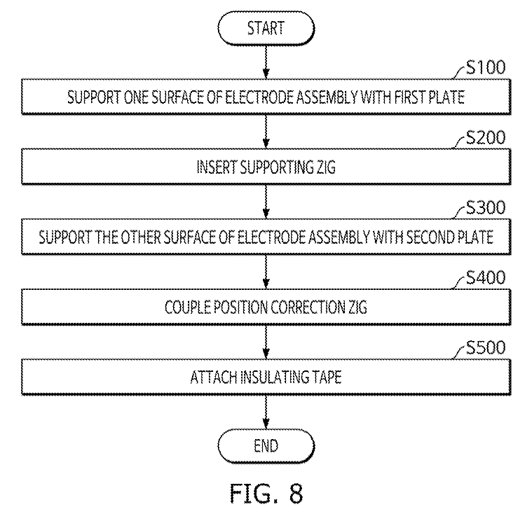

FIG. 8 is a flowchart for illustrating a method of operating the zig device for a secondary battery according to an embodiment of the present disclosure. FIGS. 9A to 9E show each process of the method of operating the zig device for a secondary battery according to an embodiment of the present disclosure.

The method of operating the zig device for a secondary battery according to an embodiment of the present disclosure may be initiated by having the first plate support one surface of the electrode assembly 200 at S100. The sub-plate 500 may be coupled to a side surface of the electrode assembly 200. The sub-plate 500 may include the connecting portion 520 and the wing portions 510 extending from each side of the connecting portion 520, and the connecting portion 520 may form a step with the wing portions 510. FIG. 9A is a perspective view of the first plate 110 supporting one surface of the electrode assembly 200 in the above-described step (S100). Thereafter, the electrode assembly may be interposed between the first plate 110 and the second plate 120.

At S200, the supporting zig 130 coupled with the second plate 120 may be inserted into the space between the electrode assembly 200 and the sub-plate 500, the sub-plate 500 coupled to a side surface of the electrode assembly 200, the electrode assembly 200 interposed between the first plate 110 and the second plate 120. The inserting of the supporting zig 130 at S200 may include inserting of the support portion 136 of the supporting zig 130 into the space between the electrode assembly 200 and the sub-plate 500. The inserting of the support portion 136 of the supporting zig 130 may include inserting of the support portion 136 into the space formed by the step of the connecting portion 520 and the wing portions 510 of the sub-plate 500. FIG. 9B is a perspective view for illustrating the above-described step (S200).

Next, at S300, the second plate 120 facing the first plate 110 and spaced apart therefrom may support the other surface of the electrode assembly 200. According to an embodiment of the present disclosure, the edge portion of the second plate 120 may be coupled to the base portion of the supporting zig 130. FIG. 9C is a perspective view of the second plate 120 supporting the other surface of the electrode assembly 200 in the step (S300).

The method of operating the zig device for a secondary battery according to an embodiment of the present disclosure may further include coupling of the position correction zig 600 with the boss portion 530 of the sub-plate 500 and the protrusion 138 of the support portion 136 at S400. FIG. 9D is a perspective view of the position correction zig 600 coupled with the boss portion 530 and the protrusion 138 in the step (S400).

The method of operating the zig device for a secondary battery according to an embodiment of the present disclosure may further include attaching of an insulating tape T to the electrode assembly 200 and the sub-plate 500 at S500. FIG. 9E is a perspective view of the electrode assembly 200 and the sub-plate 500 coupled to the electrode assembly 200 to which the insulating tape T has been attached in the step (S500). The insulating tape T may prevent the sub-plate 500 and a cap plate coupled to the sub-plate from coming into contact with each other.

In the process of manufacturing a secondary battery, an electrode assembly and a sub-plate are welded and then an insulating tape for a secondary battery is attached to an upper welded portion of the sub-plate. Here, force may be applied to the sub-plate during the process of attaching the insulating tape, so that interference with the electrode assembly may be caused, resulting in increased damage to an electrode plate, increased dispersion in the position of the sub-plate, etc.

According to various embodiments of the present disclosure, in the process of attaching the insulating tape to the electrode assembly and the sub-plate, the support portion of the supporting zig may support the sub-plate to prevent the sub-plate from being pressed. As a result, it may be possible to prevent interference between the sub-plate and the electrode assembly, which results in damage to the electrode plate.

According to various embodiments of the present disclosure, the support portion of the supporting zig may be inserted into the space formed by the step of the connecting portion and the wing portion of the sub-plate, the position correction zig may be sequentially coupled to the protrusion of the support portion and the boss portion of the sub-plate, and the position of the sub-plate may be corrected in the process of attaching the insulating tape. Therefore, it may be possible to prevent the quality or performance of a secondary battery from being deteriorated due to increased dispersion in the position of the sub-plate in the process of attaching the insulating tape.

According to various embodiments of the present disclosure, the position correction zig may be coupled with the protrusion of the supporting zig and the boss portion of the sub-plate, and may be assembled in its correct position by a magnetic force. As a result, it may be possible to prevent the dispersion in the position of the sub-plate from increasing due to the position correction zig not being assembled in its correct position.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A zig device for a secondary battery, the zig device comprising:
a first plate supporting a first surface of an electrode assembly;
a second plate supporting a second surface of the electrode assembly, the second plate facing the first plate while being spaced apart therefrom; and
a supporting zig coupled with the second plate, the supporting zig supporting a sub-plate coupled to a side surface of the electrode assembly, the electrode assembly being between the first plate and the second plate.

2. The zig device as claimed in claim 1, wherein the supporting zig comprises:
a base portion coupled to an edge portion of the second plate;
an extension portion extending from the base portion and protruding outward from the second plate; and
a support portion extending vertically from the extension portion, the support portion being between the electrode assembly and the sub-plate.

3. The zig device as claimed in claim 2, wherein a length by which the extension portion protrudes outward is equal to or greater than a length by which the electrode assembly protrudes from the second plate.

4. The zig device as claimed in claim 2, wherein the support portion comprises a magnet having a magnetic force.

5. The zig device as claimed in claim 2, wherein the support portion comprises a protrusion on an outside thereof.

6. The zig device as claimed in claim 5, wherein the sub-plate comprises a connecting portion and wing portions extending from each side of the connecting portion, the connecting portion comprising a boss portion protruding from the connecting portion.

7. The zig device as claimed in claim 6, wherein:
the connecting portion is coupled with the wing portions by a step, and
the support portion is in a space created by the step.

8. The zig device as claimed in claim 1, wherein the sub-plate includes a plurality of sub-plates coupled to the side surface of the electrode assembly, and wherein the support zig includes a plurality of supporting zigs to support the plurality of sub-plates.

9. The zig device as claimed in claim 8, wherein a distance between the plurality of supporting zigs corresponds to a distance between the plurality of sub-plates.

10. The zig device as claimed in claim 1, further comprising a clamp for clamping the first plate and the second plate.

11. The zig device as claimed in claim 6, further comprising a position correction zig coupled with the boss portion and the protrusion, the correction zig correcting a position of the sub-plate.

12. The zig device as claimed in claim 11, wherein the position correction zig comprises:
a plurality of fastening portions coupled to the boss portion and the protrusion; and
a bridge portion connecting the plurality of fastening portions.

13. The zig device as claimed in claim 12, wherein a length of the bridge portion corresponds to a distance between adjacent sub-plates of the plurality of sub-plates.

14. The zig device as claimed in claim 12, wherein the fastening portion is coupled with the protrusion and the boss portion, and wherein the fastening portion has a first hole and a second hole.

15. A method of operating a zig device for a secondary battery, the method comprising:
supporting a first surface of an electrode assembly with a first plate;
inserting a supporting zig coupled with a second plate into a space between the electrode assembly and a sub-plate, the sub-plate being coupled to a side surface of the electrode assembly, the electrode assembly being interposed between the first plate and the second plate; and
supporting a second surface of the electrode assembly with the second plate, the second plate facing the first plate and being spaced apart therefrom.

16. The method as claimed in claim 15, wherein inserting the supporting zig comprises inserting a support portion of the supporting zig into a space between the electrode assembly and the sub-plate.

17. The method as claimed in claim 16, wherein:
the sub-plate comprises a connecting portion and wing portions extending from each side of the connecting portion;
the connecting portion forms a step with the wing portion; and
the connecting portion comprises a boss portion protruding from the connecting portion.

18. The method as claimed in claim 17, wherein inserting the support portion of the supporting zig comprises inserting the support portion into a space formed by the step.

19. The method as claimed in claim 17, further comprising coupling a position correction zig with the boss portion and a protrusion of the support portion.

20. The method as claimed in claim 19, further comprising attaching an insulating tape to the electrode assembly and the sub-plate.
